(19) United States
(12) Patent Application Publication
(10) Pub. No.: US 2007/0257449 A1
(43) Pub. Date: Nov. 8, 2007

(54) Sealing molding for a Motor Vehicle

(76) Inventors: Alain Pelchat, Woodbridge (CA); Neil Moir, Richmond Hill (CA); Elio Colarossi, Richmond Hill (CA); Steve Marcon, Toronto (CA); Salem R. Nano, Sterling Heights, MI (US); Haruhisa Kawase, Rochester Hills, MI (US); Peter J. Ellis, Rochester Hills, MI (US); Carlo Haddad, Mississauga (CA); Ian Haddon, Richmond Hill (CA)

Correspondence Address: CLARK HILL, P.C., 500 WOODWARD AVENUE, SUITE 3500, DETROIT, MI, 48226, US

(21) Appl. No.: 11/629,294

(22) PCT Filed: Jun. 22, 2005
(86) PCT No.: PCT/US05/22159

§ 371 Date: Dec. 12, 2006

Related U.S. Application Data
(60) Provisional application No. 60/581,920, filed on Jun. 22, 2004.

(51) Int. Cl. F16J 15/00

(52) U.S. Cl. 277/650; 277/628

(57) ABSTRACT

A sealing molding is provided for attachment to a motor vehicle body flange. The sealing molding includes spaced apart walls defining a channel for receiving the flange. At least one retention finger extends out from one of the spaced apart walls into the channel. The retention finger includes a notch that allows the retention finger to flex relative to the spaced apart walls for retaining the flange between the spaced apart walls.

### FIELD OF THE INVENTION

The invention relates to sealing moldings for a motor vehicle body. More particularly, the invention relates to improving the retention of a sealing molding along a motor vehicle body flange.

### DESCRIPTION OF RELATED ART

In motor vehicles, it is well-known to provide a belt line molding for sealing around an opening, such as a window opening, door opening, or luggage compartment opening, of a motor vehicle body. The belt line molding is typically mounted along a sheet metal flange of the motor vehicle body that extends along the opening. The belt line molding commonly has a U-shaped channel sized to frictionally fit on the sheet metal flange for sealing the opening against intrusion of moisture.

Belt line moldings typically include a U-shaped reinforcement member, typically a metallic insert or polypropylene, that is co-extruded with a suitable elastomeric covering, typically ethylene propylene diene monomer (EPDM). The belt line molding also includes spaced apart walls connected by a base. A plurality of EPDM retention fingers extend inwardly from at least one of the walls into the space therebetween. When the belt line molding is installed over the flange, the plurality of retention fingers flex and frictionally grip the flange to retain the belt line molding thereon. The use of EPDM for each of the plurality of retention fingers provides sufficient frictional engagement for retaining the belt line molding on the flange.

It has been proposed to replace EPDM as the elastomeric material with thermoplastic vulcanizates (TPV). TPV has, however, a relatively low coefficient of friction as compared to EPDM. As a result, a molding having retention fingers formed from TPV does not produce sufficient frictional forces for retaining the molding on the flange.

Thus, it is desirable to provide a belt line molding having TPV retention fingers with improved retention capabilities.

### SUMMARY OF THE INVENTION

A sealing molding is provided for attachment to a motor vehicle body flange. The sealing molding includes a body portion including spaced apart walls defining a channel for receiving the flange. At least one retention finger extends out from one of the spaced apart walls into the channel. The retention finger includes a notch formed adjacent the wall to which it extends out from. The notches allow the retention finger to flex relative to the spaced apart walls for retaining the flange between the spaced apart walls.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a cross-sectional view of a sealing molding according to the invention;

FIG. 2 is a cross-sectional view of the sealing molding mounted along a flange of a motor vehicle body; and

FIG. 3 is a cross-sectional view of the sealing molding upon an attempted removal of the flange from the sealing molding.

### DETAILED DESCRIPTION OF THE PREFERRED EMBODIMENT

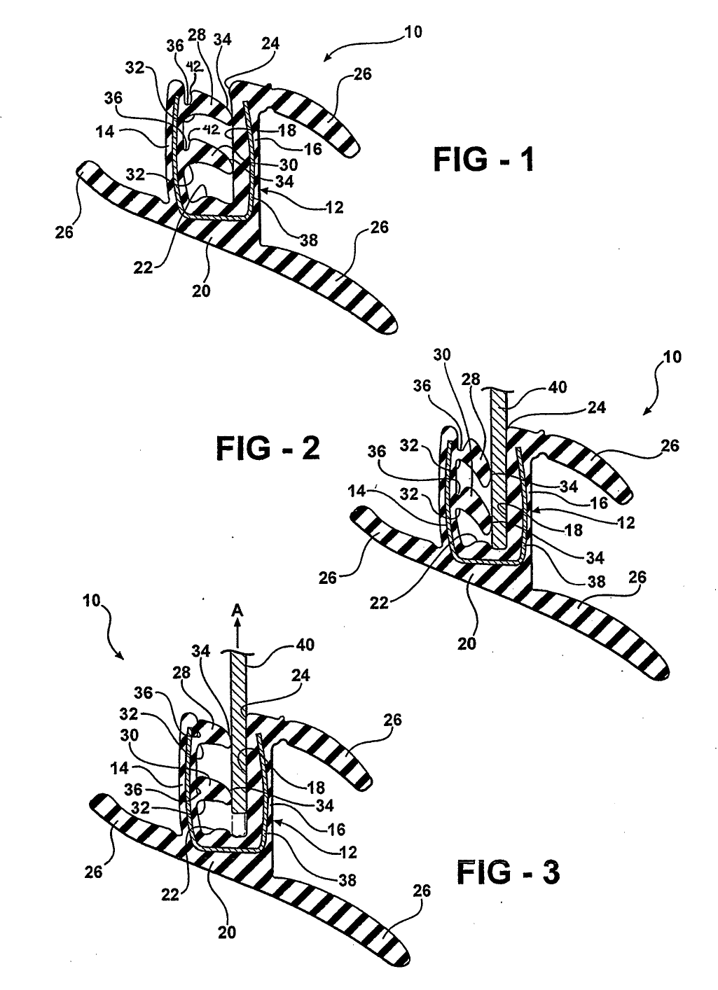

Referring to FIG. 1, a sealing molding, generally shown at 10, is provided for attachment to a motor vehicle body (not shown). The sealing molding 1Q is formed from an elastomeric material. In a preferred embodiment, the sealing molding 10 is formed from a thermoplastic vulcanizate (TPV).

The sealing molding 10 includes a body portion 12 having a pair of spaced apart walls 14, 16 defining a channel 18 therebetween. A bight portion 20 connects the pair of spaced apart walls 14, 16 and defines a closed end 22 of the channel 18. The channel 18 also includes an open end 24 opposite the closed end 22.

The sealing molding 10 also includes a plurality of sealing lips or wiper fingers 26 extending outwardly from the body portion 12. The plurality of sealing lips 26 seals against a glass panel (not shown) of a motor vehicle or cleans the glass panel as the glass panel moves against each of the plurality of sealing lips 26. The location and size of each of the plurality of sealing lips 26 will vary depending upon the particular motor vehicle on which the sealing molding 10 is utilized.

A pair of retention fingers or lips 28, 30 extends inwardly into the channel 18 from one of the pair of spaced apart walls 14. The pair of retention fingers 28, 30 is integrally formed with the wall 14 and extends angularly toward the opposing wall 16. Each of the pair of retention fingers 28, 30 includes a wall end 32 abutting the wall 14 and a distal end 34 extending into the channel 18. Each of the pair of retention fingers 28, 30 also includes a notch 36 at the wall end 32. The notches 36 allow each of the pair of retention fingers 28, 30 to flex relative to the adjacent wall 14.

A generally U-shaped reinforcement member 38 is embedded within the body portion 12 to provide the sealing molding 10 with rigidity and stability. The reinforcement member 38 may be formed from metal, metal alloy, wire, plastic, such as polypropylene, or any other suitably stiff or rigid material. The reinforcement member 38 may be co-extruded with the elastomeric material to form the sealing member 10.

The sealing molding 10 according to the invention may be used for any motor vehicle sealing that attaches to a flange extending along a body opening. Thus, the sealing molding 10 may be utilized as a belt line molding, weatherseal, or door seal. As such, the sealing molding 10 is typically an elongated component that extends along the length of the flange.

Referring to FIG. 2, the sealing molding 10 is mounted to a flange 40 of a motor vehicle body panel. More specifically, the flange 40, which is typically a painted metal, is received within the channel 18 of the sealing molding 10. As a result, the retention fingers 28, 30 are biased to exert a pressure on the flange 40 in order to retain the sealing molding 10 thereon. The retention fingers 28, 30 flex to allow ingress of the flange 40 relative to the sealing molding 10.

The pair of retention fingers 28, 30 applies a resilient force against the flange 40 to pinch the flange 40 in place between the pair of spaced apart walls 14, 16. Hence, the pair of retention fingers 28, 30 is adapted to abut against the flange 40 when the sealing molding 10 is installed on the flange 40. Each of the pair of retention fingers 28, 30 is sized and arranged in accordance with the thickness of the flange 40 and the distance between the pair of spaced apart walls 14, 16 to retain the flange 40 when the sealing molding 10 is installed on the flange 40. Thus, each of the pair of retention fingers 28, 30 can have any suitable length for sealing engagement with the flange 40. If desired, the retention fingers 28, 30 have sufficient flexibility to accommodate variances in flange thickness.

Referring to FIG. 3, when the sealing molding 10 is urged relatively away from the flange 40, each of the pair of retention fingers 28, 30 pivots relative to the wall 14 and becomes wedged between the wall 14 and the flange 40. As a result, an inner notch surface 42 of each of the pair of retention fingers 28, 30 is forced into abutment with the wall 14. The wedging or camming action of the retention fingers 28, 30 increases the pressure and thus the frictional forces acting between the retention fingers 28, 30 and the flange 40, thereby improving the retention ability of the sealing molding 10 along the flange 40.

The notches 38 allow the sealing molding 10 to overcome a low retention force between the elastomeric material and the metal flange 40, which is caused by the low coefficient of friction of the elastomeric material. This is particularly relevant when TPV is used as the elastomeric material. As a result, a significant extraction force must be exerted upon the sealing molding 10 to pull the sealing molding 10 off of the flange 40. Preferably, the extraction force required to pull the sealing molding 10 off of the flange 40 is at least approximately 40 N.

It is appreciated that although the retention fingers 28, 30 are shown and described for the sealing molding 10, the retention fingers 28, 30 set forth above may be utilized on inner and outer belts, body seals, glass runs, or any other part that is made from an elastomeric material for mounting to a flat, curved, or shaped metal.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed is:

1. A sealing molding for attachment to a motor vehicle body flange, said sealing molding comprising:
a body portion including spaced apart walls defining a channel therebetween; and
at least one retention finger extending out from one of said spaced apart walls into said channel, said at least one retention finger including a notch for allowing said retention finger to flex relative to said spaced apart walls for retaining the flange between said spaced apart walls.

2. A sealing molding as set forth in claim 1 including a reinforcement member embedded within said body portion for providing rigidity thereto.

3. A sealing molding as set forth in claim 2 wherein said at least one retention finger is formed from an elastomeric material.

4. The sealing molding as defined in claim 3 wherein said elastomeric material is TPV.

5. A sealing molding as set forth in claim 4 including at least one sealing lip extending out from said body portion.

6. A sealing molding as set forth in claim 5 wherein said at least one retention finger is integrally formed with said body portion.

7. A sealing molding for mounting along a motor vehicle body flange, said sealing molding comprising:
a body portion including spaced apart walls defining a channel to receive the motor vehicle body flange, said body portion having at least one retention finger formed from TPV extending out from one of said spaced apart walls into said channel wherein said at least one retention finger includes a notch for selectively flexing said retention finger to retain the flange between said spaced apart walls.

8. A sealing molding as set forth in claim 7 including a reinforcement member embedded within said body portion for providing rigidity thereto.

9. A sealing molding as set forth in claim 8 including at least one sealing lip extending out from said body portion.

10. A sealing molding as set forth in claim 9 wherein said reinforcement member is formed from a metal material.

11. A sealing molding as set forth in claim 9 wherein said reinforcement member is formed from a plastic material.
